(19) United States
(12) Patent Application Publication
(10) Pub. No.: US 2020/0297007 A1
(43) Pub. Date: Sep. 24, 2020

(54) REMOVING HEAVY METALS FROM RICE

(71) Applicant: Shaklee Corporation, Pleasanton, CA (US)

(72) Inventor: Teodoro T. Ianiro, Concord, CA (US)

(73) Assignee: Shaklee Corporation, Pleasanton, CA (US)

(21) Appl. No.: 16/321,587

(22) PCT Filed: Jul. 31, 2017
(86) PCT No.: PCT/US2017/044758

§ 371 Date: Jan. 29, 2019

Related U.S. Application Data
(60) Provisional application No. 62/369,623, filed on Aug. 1, 2016.

(51) Int. Cl. A23L 5/20; A23L 7/143; A23L 7/10

(52) U.S. Cl. CPC A23L 5/273; A23V 2002/00; A23L 7/197; A23L 7/143

(57) ABSTRACT

Harvested rice is combined with water and a process aid to provide a mixture of rice, water and the process aid. The combination is maintained for a time sufficient for at least a portion of heavy metal contaminants, predominantly heavy metal ions, to be separated from the rice. Thereafter, at least a portion of the water and the process aid are separated from the combination, leaving rice that has a reduced content of heavy metals.

### CROSS REFERENCE TO RELATED APPLICATION

This claims the benefit of U.S. Provisional Application No. 62/369,623, filed Aug. 1, 2016, which is incorporated by reference herein in its entirety.

### FIELD

This disclosure concerns treatment of harvested rice to remove heavy metals.

### BACKGROUND

Rice is one of the most commonly consumed food crops. It is an abundant and inexpensive source for the development of various high quality protein level products.

It is a problem that rice plants readily take up metals, including toxic heavy metals such as arsenic, cadmium, lead, and mercury, from the soil and water in which the plants are grown. It is a particular problem that rice plants store such heavy metals in the grain, not just in the leaves and stems. Harvested rice therefore typically contains heavy metals, particularly lead, sometimes in amounts that may be toxic to consumers who ingest rice on a regular basis, which is of great concern with regard to public health. Brown rice, which is also referred to herein as “whole rice” or “unpolished rice,” typically has a higher content of heavy metals than white rice. This is because heavy metals tend to accumulate in rice bran, which is polished off during the production of white rice.

Various methods are known for removing heavy metals from process streams, but most such processes employ hydrocarbon solvents or harsh processing conditions that are not appropriate for the treatment of a food such as rice.

Therefore there is a need for an environmentally safe and economical method to remove heavy metals from harvested rice. Although the need is greatest for brown rice, removal of heavy metals from white rice also would be beneficial.

### SUMMARY

Harvested rice is combined with water and a process aid to provide a mixture of rice, water and the process aid. The mixture is maintained in a vessel for a time sufficient for at least a portion of heavy metal contaminants, predominantly heavy metal ions, to be separated from the rice. Thereafter, at least a portion of the water and the process aid are separated from the mixture, leaving rice that has a reduced content of heavy metals. The process aid best is an organic substrate, advantageously activated carbon. The process aid is of sufficient particle size as to be easily separated from the treated rice.

The treatment is simple to perform, uses only water and the process aid, and can be performed in a single vessel that has temperature control and mixing capabilities.

By this process, the content of lead (Pb) and other heavy metal (As, Hg, and Cd) can be reduced by 95% and 30% respectively, or more, without using a hydrocarbon solvent. The proteinaceous content of the treated rice is essentially unaffected, with the treated rice retaining greater than 99% of its naturally occurring content. There also is good retention of fiber, approximately 80%.

The foregoing and other features and advantages of the invention will become more apparent from the following detailed description, which proceeds with reference to the accompanying FIGURE.

### BRIEF DESCRIPTION OF THE DRAWING

FIG. 1 is a flow chart of a method for removing heavy metals from whole rice.

### DETAILED DESCRIPTION

The following explanations of terms and abbreviations are provided to better describe the present disclosure and to guide those of ordinary skill in the art in the practice of the present disclosure. As used herein, “comprising” means “including.” “Consisting essentially of” means “including the specified item(s) and also items that do not materially affect the basic characteristics of the specified item(s).” The singular forms “a” or “an” or “the” include plural references unless the context clearly dictates otherwise. The term “or” refers to a single element of stated alternative elements or a combination of two or more elements, unless the context clearly indicates otherwise.

Unless explained otherwise, all technical and scientific terms used herein have the same meaning as commonly understood to one of ordinary skill in the art to which this disclosure belongs. Although methods and materials similar or equivalent to those described herein can be used in the practice or testing of the present disclosure, suitable methods and materials are described below. The materials, methods, and examples are illustrative only and not intended to be limiting. Other features of the disclosure are apparent from the following detailed description and the claims.

Unless otherwise indicated, all numbers expressing dimensions, quantities, temperatures, times, and so forth, as used in the specification or claims are to be understood as being modified by the term “about.” Accordingly, unless otherwise implicitly or explicitly indicated, or unless the context is properly understood by a person of ordinary skill in the art to have a more definitive construction, the numerical parameters set forth are approximations that may depend on the desired properties sought and/or limits of detection under standard test conditions/methods as known to those of ordinary skill in the art. When directly and explicitly distinguishing embodiments from discussed prior art, the embodiment numbers are not approximates unless the word “about” is recited.

Unless otherwise indicated, all percentages referring to a composition or material are understood to be a percent by weight, i.e., % (w/w).

In order to facilitate review of the various embodiments of the disclosure, the following explanations of specific terms are provided:

Brown rice: As used herein, the terms “brown rice,” “unpolished rice,” “whole rice,” and “whole grain rice” refer to harvested rice grains from which the outer hull or husk has been removed.

White rice: As used herein, the terms “white rice” and “polished rice” refer to rice grains formed by milling and/or polishing brown rice to remove the bran layer and germ.

Heavy metals: As used herein, the term “heavy metals” refers to arsenic, cadmium, lead, and mercury.

In processes according to the present invention, harvested rice is combined with water and a process aid to provide a mixture of rice, water and the process aid. Best results are achieved with the use of deionized water, but the water need not be deionized for successful operation. The mixture is maintained in a vessel for a time sufficient for at least a portion of the heavy metals to be separated from the rice. Thereafter, at least a portion of the water and the process aid are separated from the mixture, producing rice that has a reduced content of heavy metals.

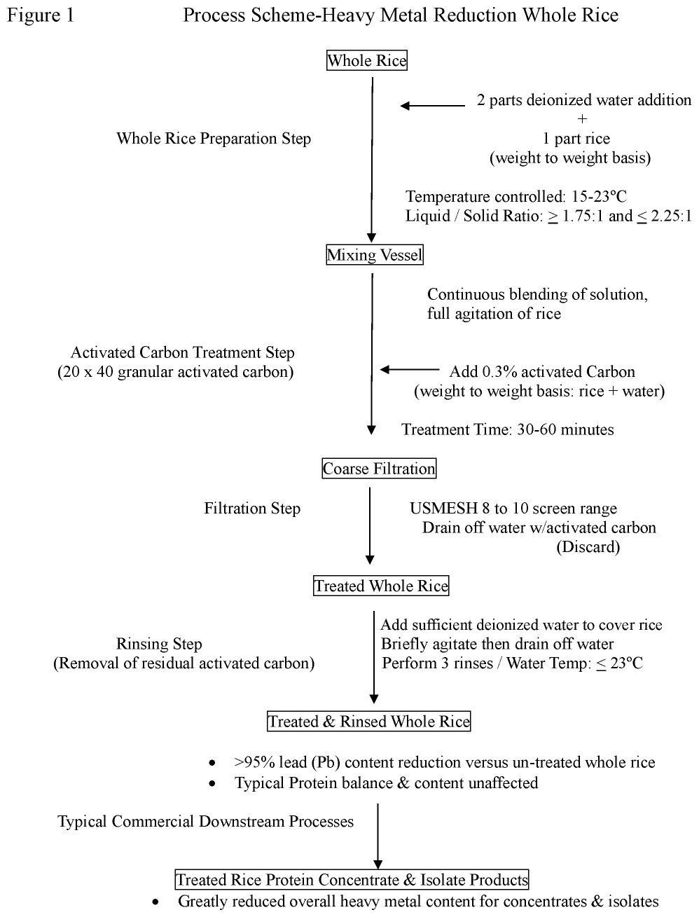

FIG. 1 illustrates one such process for the treatment of whole rice. In that process, whole rice and deionized water are combined at a liquid to solid range ratio of ≥1.75:1 and ≤2.25:1 on a weight to weight basis in an appropriately sized vessel that has mixing and temperature control capabilities. Operation is possible with a higher amount of water. The ratio should be such that the rice is submerged and easy to agitate. An extraction ratio of up to 2.5:1 should be operable, as should a ratio of up to 3:1. A liquid to solid range ratio of ≥1.75:1 and ≤2.5:1 on a weight to weight basis should be operable. However, the use of excess water could reduce the binding efficiency of the heavy metals and affect the nutrient profile of the rice. The use of excess water could also increase processing time and processing costs in a commercial scale operation. Advantageously, two parts deionized water are combined with one part whole rice on a weight to weight basis. The deionized water is added to the vessel and chilled to a temperature in the range of 15-23° C. While stirring the chilled water, the whole rice is added to the water in the vessel to form a mixture of rice and water. Agitation is continued after the addition of the rice. Advantageously, the temperature of the mixture is maintained at no more than 23° C. after addition of the rice. The process can be performed at a temperature somewhat above 23° C., in particular at a temperature of up to 25.6° C. Operation at too high a temperature will cause significant extraction of proteinaceous material, which is not desired. Operation at a temperature of as low as 5° C. is possible and may be advantageous on a production scale. A temperature range of 5-25.6° C. thus is operable, particular temperature ranges of 5-23° C. and 15-25.6° C. being appropriate for commercial production in some instances. The mixture of whole rice and water should be agitated by stirring fully but not so vigorously as to damage the rice. Damage can be avoided by use of an appropriate mixing speed and stirring-blade configuration. The rice can be agitated by another technique, such as shaking, but stirring is cost-effective and believed to produce the best results.

The process aid then is added to the mixture of water and rice. The process aid is added in an amount of 0.05% to 1.0% on a weight to weight basis (weight of process aid to weight of the mixture of water and rice). Advantageously, the process aid is added in an amount of 0.3% on a weight to weight basis. In an advantageous embodiment, activated carbon is added to the mixture of water and rice in an amount of 0.3% on a weight to weight basis (weight of activated carbon to weight of the mixture of water and rice). The activated carbon particle size is a 20×40 granular form. The mixture of water, rice and activated carbon is mixed for a minimum of 30 minutes but not more than 60 minutes. Operating under these conditions results in rapid binding of heavy metal ions while avoiding removal of proteinaceous material within the rice matrix. As mixing time increase above 60 minutes, proteinaceous material begins to be extracted out and the rice structure breaks down, thus making the filtering process difficult.

The activated carbon can be of any type that is of sufficient purity for use in the treatment of food. Popular activated carbon source materials are: coconut, coal, and wood. Granular activated carbon (GAC) is the best form of activated carbon for use with the processes described herein. Granular activated carbon (GAC) at a size range of 20×40 would have at least 90% pass-through on a USMESH 20 sieve (0.85 mm) and 95% retention on a USMESH 40 sieve (0.42 mm). Granular activated carbon (GAC) is primarily suited for use in aqueous phase systems. Activated carbon of a smaller particle size will work; however, the best particles to use are sized to be retained predominantly on a filer having a screen of 10 USMESH or larger.

After the treatment with activated carbon, water is drained from the mixing vessel using a coarse filtration process. Advantageously, a filter having a screen of 8 to 10 USMESH is used to separate water and activated carbon from the mixture. In some instances, agitation of the mixture during the filtration process is beneficial. At least a portion of the water and at least a portion of the granular activated carbon pass through the screen to a location outside the vessel. Whole rice retained in the vessel by the screen has a reduced content of heavy metals as compared to the content of heavy metals in the rice before the treatment.

The whole rice retained in the vessel advantageously is further purified in the same vessel by a rinsing process in which sufficient deionized water is added to fully cover the rice. The mixture of rice and water then is briefly agitated. Agitation for 1 to 2 minutes can be helpful to remove residual process aid that may be present on the rice. Water, possibly along with some residual activated carbon, then is removed from the mixture by draining the vessel, advantageously via a filer having a screen of 8 to 10 USMESH. In some instances, it is beneficial to agitate the mixture during the draining. This rinsing process may be performed plural times. Advantageously, the rinsing process will be performed at least three times. Conducting the rinsing process three times has been sufficient to remove substantially all leftover activated carbon fines. During the entire time that the rice is in contact with water in the vessel, the mixture of rice and water should not exceed 25.6° C. to avoid undue removal of proteinaceous material from the rice, and best should not exceed 23° C.

Table 1 shows the content of heavy metal contaminants, fiber, protein, and simple sugar for non-treated whole rice and for comparable whole rice that was treated by the method described above, with three rinsing steps.

TABLE 1
Component Profiling
Whole Rice

| Component | Non-Treated | | Treated | | % Reduction: |
|---|---|---|---|---|---|
| Tested | (Control) | | (activated carbon) | | Treated Sample |
| Protein | 7.94% | | 7.89% | | 0.63% |
| Total Dietary Fiber | 5.81% | | 4.63% | | 20.30% |
| Simple Sugars | 1.59% | | 0.69% | | 56.60% |
| Pb (Lead) | 0.85 | PPM* | 0.014 | PPM* | 98.35% |
| As (Arsenic) | 0.30 | PPM* | 0.20 | PPM* | 33.33% |
| Hg (Mercury) | <0.05 | PPM* | <0.05 | PPM* | Not detectable |
| | | | | | per assay |
| | | | | | results |
| Cd (Cadmium) | <0.05 | PPM* | <0.05 | PPM* | Not detectable |
| | | | | | per assay |
| | | | | | results |

*Detection Limit: 0.005 PPM for lead (Pb) and 0.05 PPM arsenic (As), mercury (Hg), and cadmium (Cd)

The treated and rinsed whole rice can be used in existing commercial processes to prepare enriched protein ingredients, such as concentrates and isolates. Therefore, the process of treating whole rice as described above enables existing commercial processes to enhance protein from rice with a greatly reduced heavy metal content, especially lead (Pb). Additionally, the treatment process described above reduces total soluble fiber content by over 20% (predominantly soluble form) and simple sugars by >50%, thus creating a lower caloric product for cooked whole rice that is greatly reduced in heavy metals.

Although the example above describes treatment of whole rice, it should be understood that the process can be extended beyond just the treatment of whole rice. The process also can be applied to treat white rice, which does not contain the bran and germ components of the rice kernel. One example method for treating white rice would be the exact same process described above, except that white rice would be added to water in the vessel instead of whole rice. White rice is generally fortified, so the heavy metal removal process best would be conducted before any product fortification takes place. The treatment of white rice is less critical than the treatment of whole rice because whole rice typically has a higher content of heavy metals due to the presence of the rice bran. Nevertheless, because white rice is consumed on a much higher level than brown rice due to its high starch content providing a useful energy source, removing heavy metals from the endosperm of white rice provides a substantial health benefit to the consumer.

In the processes described herein, all or a portion of the activated carbon could be replaced with another process aid material. It is believed that the mechanism of action is predominantly ionic binding of heavy metals with substrates that are negatively charged. Therefore a substitute process aid material best possesses a negative charge. For example, a substitute process aid could be activated carbon particles that have been surface-modified to increase the negative charge of the activated carbon. Zeolites are microporous aluminosilicate minerals, of which clinoptilolite is an example. Food grade clinoptilolite will work extremely well as a process aid in any of the processes described herein. Substitute process aids best will be in the form of particles of the size discussed above with regard to activated carbon, for example, 20×40 particle size is appropriate for clinoptilolite granules and other substitute process aids.

Microbeads of calcium alginate would also be quite effective as a process aid, essentially heavy metal ions would exchange with calcium ions attached to the alginate matrix (seaweed based) through competitive binding (Le Châtelier's principle). This particular organic substrate was tested versus activated carbon and was found to remove lead (Pb) content at a level of ˜95%. However, even though this material is quite inexpensive and abundant, activated carbon is even more so and is easier to handle when treating the rice matrix.

Although advantageous results are achieved with the particular processes described above, variations are possible. The order of mixing of the rice, water, and process aid could be changed. A mixture of water and process aid could be formed and then rice added to that mixture. It also would be possible to form a dry mixture of rice and process aid, and then water added to the dry mixture. If a particular order of mixing of the components is advantageous for operation on a production scale, then the order of mixing can be changed to make the process more efficient from a production standpoint. Most production scale processes for rice involve soaking/cleaning of rice after harvest, so in some instances the process aid can be incorporated during this step in the production process. The process aid also, in some instances, can be used in a standardized production process to concentrate protein from rice other than at the beginning of the process where soaking/cleaning of the rice usually takes place. Incorporating this process midstream or further downstream can be useful to reduce costs on a production scale and to make the overall process smoother. The process aid could be used at a different point in the rice protein concentration process where further filtering, mixing, and cleaning steps take place if amenable. The most important operational criteria are mixing time, water temperature, liquid to solid ratios, and ensuring rice is not damaged during blending with the process aid that is used to reduce heavy metal content.

The processes described above are batch processes. A flow of rice can be processed continuously or in periodic pulses using the same process parameters. For example, an apparatus for processing a flow of rice could comprise an extractor vessel (having chilling, mixing, and draining capabilities), a conveyor for continuously or periodically loading rice into the extractor vessel, a holding tank (having chilling and mixing capabilities) to hold a mixture of DI water and process aid, a holding tank (having chilling capabilities) containing DI water only, a separator unit for separating solids from liquid, a dryer, and a sifter unit, and various transfer pumps for moving fluids between vessels.

A sequence of batch extractor vessels, as many as twelve in a row, can be provided where each vessel has a tank of about 2,000 gallons overall volume capacity. Each tank would have mixing capabilities and solution temperature control via a glycol chilling system. After rice is added into the individual extractors via a conveyor, a mixture of chilled water and process aid is pumped into each extractor vessel for mixing. After the mixing is completed, each extractor would be drained to remove as much water as possible. DI water then would be pumped into each tank to briefly rinse the rice, followed by draining once again to remove the bulk of the left over activated carbon fines. Finally, enough fresh/chilled DI water would be pumped into each extractor vessel to transfer the rice to a separator unit wherein water would be removed from the rice. In the event that rice could be damaged by pumping to the separator, the apparatus could be constructed such that the mixture of rice, water and process aid would drain from the bottom of the extractor vessels directly into separators by gravity rather than pumping. Separated rice would then be transferred to a drying unit for drying. The dried rice then would be sifted and packaged for consumption. Drying of the separated rice would not necessarily be required if the separated rice is to be used as a feedstock for a commercial protein concentration process. By feeding and draining the extractor vessels sequentially, it would be possible to produce a substantially continuous flow of treated rice form the sequence of batch extractor vessels.

A continuous or periodic process could also be performed using a single extraction vessel having one or more component inlets that are spaced apart from one or more component outlets, with a passageway extending between an inlet region adjacent to the inlets and an outlet region adjacent to the outlets. In such a process rice would be continuously or periodically added into the inlet region of the passageway via a conveyor. Chilled water and process aid also would be continuously or periodically conveyed into the inlet region of the passageway of the extractor vessel for mixing with the rice. The mixture of rice, water and process aid then would flow through the passageway toward the outlet region. While flowing from the inlet region to the outlet region, the mixture would be stirred by mixing blades or the passageway could be defined by a cylindrical rotary tank that would rotate and thereby tumble the mixture as it moves from the inlet region to the outlet region. Rinsing stations could be provided at spaced apart locations along the passageway to drain water and process aid from the passageway and to add fresh water for rinsing. Once rice reaches the outlet region it is discharged from the passageway through one or more of the outlets. The discharged rice would be conveyed to a separator unit wherein water would be separated from the rice. The rice then would be dried or transported to a commercial protein concentration facility.

While one or more embodiments of the present invention have been illustrated in detail, the skilled artisan will appreciate that modifications and adaptations to those embodiments may be made without departing from the scope of the present invention as set forth in the following claims.

1. A method for treating rice that contains heavy metals, the method comprising:
combining rice that contains heavy metals with a process aid and water to provide a mixture of rice, process aid, and water;
maintaining the rice in contact with the process aid and the water in a vessel for a time sufficient for at least a portion of the heavy metals to be separated from the rice; and
separating the process aid and water from the mixture to provide rice having a reduced content of heavy metals.

2. The method of claim 1 wherein the combining comprises:
combining the rice with the water at a liquid to solid range ratio from 1.75:1 to 2.25:1 on a weight to weight basis; and
including the process aid in an amount of from 0.05 wt. % to 1.0 wt. % of the combined weight of rice and water.

3. The method of claim 2 wherein the combining comprises:
combining the rice with the water at a ratio of 2 parts water to 1 part rice on a weight to weight basis to form a mixture of rice and water; and
then adding 0.3 wt. % of the process aid to the mixture of rice and water.

4. The method of claim 1 wherein the combining comprises:
providing the water in the vessel at a temperature of 15-23° C.;
adding the rice to the water that is at a temperature of 15-23° C. to form a mixture of rice and water; and
agitating the mixture of rice and water by stirring the mixture of rice and water while maintaining the temperature of the mixture of rice and water at 15-23° C.;
then adding the process aid to the mixture of rice and water.

5. The method of claim 1 wherein the maintaining comprises maintaining the rice in contact with the process aid and the water for a period of 30 minutes to 60 minutes.

6. The method of claim 1 further comprising:
after the separating, adding water at a temperature of 15-23° C. to the rice having a reduced content of heavy metals to form a mixture comprising water and rice having a reduced content of heavy metals;
agitating the mixture of water and rice having a reduced content of heavy metals while maintaining the mixture of water and rice having a reduced content of heavy metals at a temperature of 15-23° C.; and
separating water from the mixture of water and rice having a reduced content of heavy metals.

7. The method of claim 8 further comprising sequentially performing the steps of claim 6 plural times.

8. The method of claim 1 wherein the water added to the vessel is deionized water.

9. The method of claim 1 further comprising:
continuously or periodically adding a portion of the rice, the activated carbon and the water into the vessel; and
continuously or periodically removing a portion of the rice, the process aid and the water from the vessel.

10. The method of claim 1 wherein the process aid consists essentially of activated carbon, surface-modified activated carbon, a form of zeolite, calcium alginate, or a mixture thereof.

11. The method of claim 1 wherein the process aid consists essentially of granular activated carbon.

12. The method of claim 11, wherein:
the granular activated carbon has a particle size range of USMESH 20 to USMESH 40; and
the filter is a screen of 8 to 10 USMESH.

13. The method of claim 1 wherein:
the process aid consists essentially of granular activated carbon; and
the separating comprises draining the vessel through a filter having a pore size sufficient to retain the rice and to pass at least a portion of the water and at least a portion of the granular activated carbon through the filter to a location outside the vessel.

14. The method of claim 1 wherein the rice is whole rice.

15. A method for treating whole rice that contains heavy metals, the method comprising:
combining whole rice that contains heavy metals with water that is at a temperature of 15-23° C. at a liquid to solid range ratio of 1.75:1 to 2.5:1 on a weight to weight basis to form a mixture of whole rice and water;
agitating the mixture of whole rice and water while maintaining the temperature of the mixture of whole rice and water at 5.0-25.6° C.;
then adding from 0.05 wt. % to 1.0 wt. % granular activated carbon having a particle size of 20×40 USMESH to the mixture of whole rice and water to provide a mixture of whole rice, activated carbon, and water;
maintaining the whole rice in contact with the activated carbon and the water at a temperature of 5.0-25.6° C. in a vessel for a period of from 30 minutes to 60 minutes; and
draining the vessel through a screen of 8 to 10 USMESH to pass at least a portion of the water and at least a portion of the granular activated carbon to a location outside the vessel and to retain the whole rice and thereby provide whole rice having a reduced content of heavy metals;
after the draining, adding water at a temperature of 5.0-25.6° C. to the whole rice having a reduced content of heavy metals to form a mixture comprising water and whole rice having a reduced content of heavy metals;
agitating the mixture of water and whole rice having a reduced content of heavy metals while maintaining the mixture of water and whole rice having a reduced content of heavy metals at a temperature of 5.0-25.6° C.; and
separating water from the mixture of water and whole rice having a reduced content of heavy metals.

16. A method for treating whole rice that contains heavy metals, the method comprising:
combining whole rice that contains heavy metals with water that is at a temperature of 15-23° C. at a liquid to solid range ratio of 1.75:1 to 2.25:1 on a weight to weight basis to form a mixture of whole rice and water;
agitating the mixture of whole rice and water while maintaining the temperature of the mixture of whole rice and water at 15-23° C.;
then adding from 0.05 wt. % to 1.0 wt. % granular activated carbon having a particle size of 20×40 USMESH to the mixture of whole rice and water to provide a mixture of whole rice, activated carbon, and water;
maintaining the whole rice in contact with the activated carbon and the water at a temperature of 15-23° C. in a vessel for a period of from 30 minutes to 60 minutes; and
draining the vessel through a screen of 8 to 10 USMESH to pass at least a portion of the water and at least a portion of the granular activated carbon to a location outside the vessel and to retain the whole rice and thereby provide whole rice having a reduced content of heavy metals;
after the draining, adding water at a temperature of 15-23° C. to the whole rice having a reduced content of heavy metals to form a mixture comprising water and whole rice having a reduced content of heavy metals;
agitating the mixture of water and whole rice having a reduced content of heavy metals while maintaining the mixture of water and whole rice having a reduced content of heavy metals at a temperature of 15-23° C.; and
separating water from the mixture of water and whole rice having a reduced content of heavy metals.
